(19) United States
(12) Patent Application Publication
(10) Pub. No.: US 2024/0193972 A1
(43) Pub. Date: Jun. 13, 2024

(54) Text Recognizing Device and Recognizing Method Thereof

(71) Applicants: Hyundai Motor Company, Seoul (KR); Kia Corporation, Seoul (KR)

(72) Inventors: Uihyun Jeong, Seoul (KR); Hunjae Rhee, Seoul (KR); Hwejin Jung, Seoul (KR)

(21) Appl. No.: 18/356,757

(22) Filed: Jul. 21, 2023

(30) Foreign Application Priority Data
Dec. 13, 2022 (KR) 10-2022-0173819

(51) Int. Cl. G06V 30/146; G06T 7/80; G06V 30/14; G06V 30/18

(52) U.S. Cl. CPC G06V 30/1463; G06T 7/80; G06V 30/1444; G06V 30/147; G06V 30/1801

(57) ABSTRACT

An embodiment text recognition device includes a character position recognizer configured to recognize individual characters in an image, and the character position recognizer is also configured to recognize a position of each of the individual characters, a correction processor configured to set a main region, the correction processor further being configured to perform one or both of correcting a slope of the main region and magnification calibration for at least one character recognized by the character position recognition part, and a text recognizer configured to perform text recognition in the main region corrected by the correction processor.

### CROSS-REFERENCE TO RELATED APPLICATIONS

This application claims the benefit of Korean Patent Application No. 10-2022-0173819, filed on Dec. 13, 2022, which application is hereby incorporated herein by reference.

### TECHNICAL FIELD

The disclosure relates to a text recognition device and a text recognition method.

### BACKGROUND

An optical character recognition technology is for recognizing characters in an image with characters as digital information. Conventionally, when images and characters are included together, characters are recognized using a text detection model and a text recognition model.

A text detection model is trained for identifying a position of a region of interest (ROI) in an image. The text detection model selects a text region based on a possibility, and excludes an area with a value less than a reference value despite a similarity to the text region from the text region. Also, the text detection model does not recognize individual characters in text.

After recognizing the position of text using the above text detection model, individual characters in the region of interest are recognized using a text recognition model. The text recognition model is trained for recognizing individual characters. A performance of text recognition model may be guaranteed in an environment where specific conditions such as illumination, brightness, horizontality, and size are satisfied.

As such, in recognizing text in an image using the text detection model and the text recognition model, when characters are tilted or character size is small in a region of interest, a character recognition rate is reduced. Also, because two models are continuously used, development and maintenance to secure individual model performances may be complicated.

### SUMMARY

The disclosure relates to a text recognition device and a text recognition method. Particular embodiments relate to a text recognition device and a text recognition method that may recognize characters engraved on a metal plate, and the like.

An embodiment of the disclosure provides a text recognition device and a text recognition method that may robustly recognize text regardless of position, tilted angle, and size of characters in an image.

Additional embodiments of the disclosure will be set forth in part in the description which follows and, in part, will be obvious from the description, or may be learned by practice of the disclosure.

In an embodiment of the disclosure, a text recognition device may include a character position recognition part configured to recognize individual characters in an image captured by a camera, and recognize a position of each of the individual characters. In an embodiment, the text recognition device further includes a correction processing part configured to perform at least one of setting a main region, correcting a slope of the main region, or magnification calibration for at least one character recognized by the character position recognition part. In an embodiment, the text recognition device further includes a text recognition part configured to perform final text recognition in the main region corrected by the correction processing part.

In an embodiment, the correction processing part may be configured to distinguish an area forming a group among a plurality of text regions, by using at least one of an overlapping length or a spaced length of two adjacent text regions.

In an embodiment, based on a plurality of groups being existent, the correction processing part may be configured to select one from the plurality of groups as the main region.

In an embodiment, the correction processing part may be configured to select a group with a largest number of text regions from the plurality of groups as the main region.

In an embodiment, the correction processing part may be configured to calculate a tilted angle of the main region and make correction in a horizontal direction, based on the main region being tilted.

In an embodiment, the correction processing part may be configured to calculate center point coordinates of a plurality of text regions in the main region and calculate the slope of the main region using the center point coordinates of the plurality of text regions to calculate the tilted angle of the main region.

In an embodiment, the correction processing part may be configured to calculate a size and coordinates of an image box to be cut out from the image, to calibrate a magnification of a text region included in the main region.

In an embodiment, the text recognition part may be configured to perform text recognition in the main region based on inference.

In an embodiment, at least one of the character position recognition part or the text recognition part may be configured to perform text recognition using a text recognition model.

In accordance with an embodiment of the disclosure, a text recognition method may include recognizing individual characters and a position of each of the individual characters in an image captured by a camera. In an embodiment, the text recognition method further includes setting and selecting a main region for at least one recognized character. In an embodiment, the text recognition method further includes calibrating a magnification of the selected main region.

In an embodiment, the text recognition method further includes performing final text recognition in the main region where the magnification is calibrated.

In an embodiment, the selecting of the main region may include regionalizing a target by setting a text region for the recognized individual characters, and selecting the main region from a plurality of groups.

In an embodiment, the regionalizing of the target may distinguish an area forming a group among a plurality of text regions, by using at least one of an overlapping length and a spaced length of two adjacent text regions, for regionalization.

In an embodiment, the selecting of the main region from the plurality of groups may select a group with a largest number of text regions from the plurality of groups as the main region.

In an embodiment, the text recognition method may further include correcting a slope of the selected main region, based on the selected main region being tilted, and the calibrating of the magnification may calibrate the magnification in the image where the slope is corrected.

In an embodiment, the correcting of the slope may calculate a tilted angle of the main region and make correction in a horizontal direction.

In an embodiment, the correcting of the slope may calculate center point coordinates of a plurality of text regions in the main region and calculate the slope of the main region using the center point coordinates of the plurality of text regions to calculate the tilted angle of the main region.

In an embodiment, the calibrating of the magnification may calculate a size and coordinates of an image box to be cut out from the image, to calibrate the magnification.

In an embodiment, the performing of the final text recognition may perform text recognition in the main region based on inference.

In an embodiment, at least one of the recognizing of the position of each of the individual characters or the performing of the final text recognition may use a text recognition model to perform text recognition.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a block diagram illustrating a text recognition device according to an embodiment;

FIG. 2 is a diagram illustrating an example of a metal plate to recognize text using a text recognition device according to an embodiment;

FIG. 3 is a diagram illustrating regionalization when text regions are spaced apart from each other using a text recognition device according to an embodiment;

FIG. 4 is a diagram illustrating regionalization when text regions are overlapped to each other using a text recognition device according to an embodiment;

FIG. 5 is a diagram illustrating an example of setting a main region using a text recognition device according to an embodiment;

FIG. 6 is a diagram illustrating correction of a slope of a main region using a text recognition device according to an embodiment;

FIG. 7 is a diagram illustrating an example of a corrected slope of a main region using a text recognition device according to an embodiment;

FIG. 8 is a diagram illustrating an example of setting an image box for magnification calibration using a text recognition device according to an embodiment;

FIG. 9 is a diagram illustrating final text recognition using a text recognition device according to an embodiment; and

FIG. 10 is a flowchart illustrating a text recognition method according to an embodiment.

### DETAILED DESCRIPTION OF ILLUSTRATIVE EMBODIMENTS

Hereinafter, embodiments will be described in detail with reference to the accompanying drawings. The embodiments disclosed below are illustrative of the technical idea of the disclosure, and those skilled in the art will appreciate that various modifications, changes, and substitutions may be made without departing from the essential characteristics thereof. Parts irrelevant to description are omitted in the drawings in order to clearly explain embodiments. In the drawings, a width, length, thickness, and the like of constituent components may be exaggerated for convenience. Like reference numerals throughout the specification denote like elements.

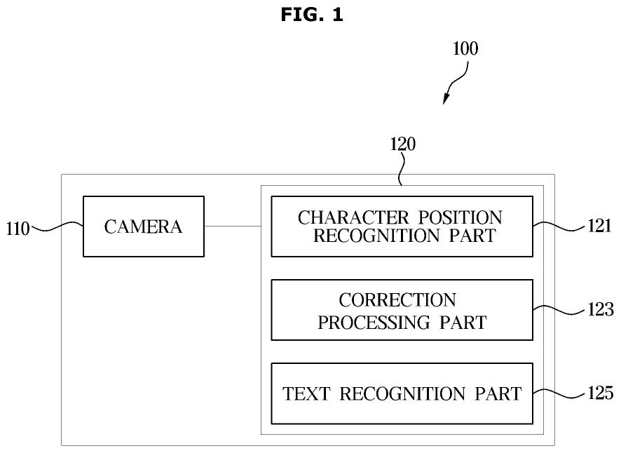

Referring to FIGS. 1 to 8, an embodiment of a text recognition device 100 is described. The text recognition device 100 according to an embodiment may recognize text on a metal plate MP, and the like, on which characters are engraved and/or inscribed, for example. The text recognition device 100 may include a camera 110 and an image processor 120.

In an embodiment and example usage, the camera 110 captures the metal plate MP, and the like, on which characters are engraved and/or inscribed, and generates an image. Because characters are engraved on the metal plate using a laser or a scribing method, characters may not be easily separated from background as compared to when scanning a paper, and the like. A bolt, etc., may be placed to couple with the metal plate. In addition, while manufacturing the metal plate, scratches may occur or characters or patterns written by a worker for convenience may exist, and thus the scratches generated on the metal plate may have a structure similar to the characters.

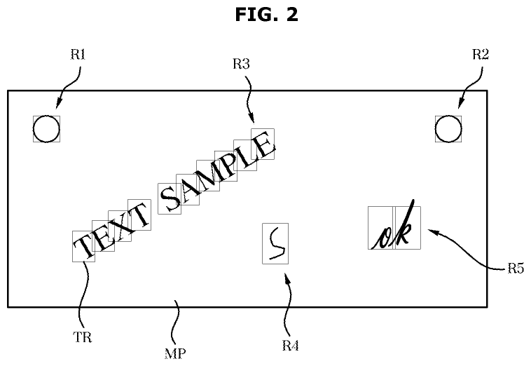

FIG. 2 illustrates an example of a metal plate MP including a first region R1 and a second region R2 which are metal portion such as a bolt, and the like, for coupling the metal plate, a third region R3 which is engraved text, a fourth region R4 which is a scratch generated during manufacturing, and a fifth region R5 which is characters handwritten by a worker, for example. To recognize text engraved on the metal plate, the camera 110 captures an image of the metal plate MP.

The image processor 120 recognizes text by processing an image captured by the camera 110. In an embodiment, the image processor 120 may include a character position recognition part (a character position recognizer) 121, a correction processing part (a correction processor) 123, and a text recognition part (a text recognizer) 125.

In an embodiment, the character position recognition part 121 recognizes positions of individual characters in the image in units of individual characters. The character position recognition part 121 may recognize the characters and coordinate values of positions of the characters. For example, in the embodiment, when recognizing a character, the character position recognition part 121 may recognize all recognizable areas of the entire metal plate regardless of a slope, and the like, of the character(s). When tilted characters are engraved on the metal plate MP as shown in FIG. 2, for example, the character position recognition part 121 may recognize the characters in third region R3 as being tilted.

Also, the character position recognition part 121 may generate position coordinates of the characters recognized in units of individual characters. Here, the position coordinates may be generated in a form of (^{x}min: ^{y}min: ^{x}max, ^{y}max), for example.

In an embodiment, the character position recognition part 121 recognizes the characters using a text recognition model, for example.

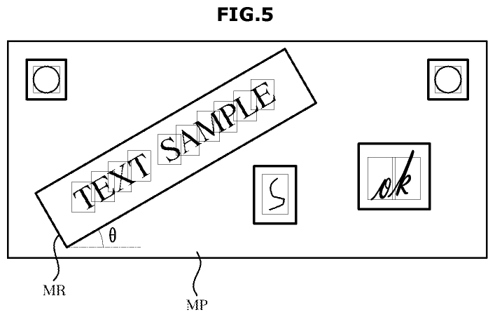

In an embodiment, the correction processing part 123 may set a text region TR (as shown in FIG. 2 for example) for at least one character recognized by the character position recognition part 121 and a main region MR (as shown in FIG. 5 for example) for processing. Then, the correction processing part 123 may perform slope correction and/or magnification calibration. In a state where a text region TR is individually set for each of the plurality of characters included in the image, the correction processing part 123 may perform regionalization of a target using positions of the text regions, for example.

When a plurality of characters is arranged in an image, the regionalization of target may be performed to distinguish characters forming a single group among the plurality of characters. For example, referring to FIG. 2, the correction processing part 123 performs regionalization to distinguish a group having ten letters of ‘TEXT SAMPLE’ from a group having two letters of ‘ok’.

In an embodiment, when two text regions are spaced apart from each other, the correction processing part 123 may perform regionalization by using an overlapping length and/or a spaced length of a first text region TR1 and a second text region TR2 relative to each other.

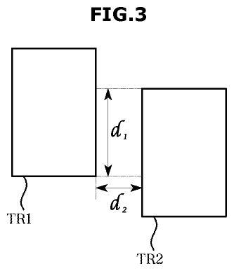

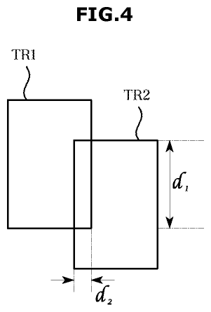

For example, when the first text region TR1 and the second text region TR2 are arranged as shown in FIGS. 3 and 4, coordinates of the first text region TR1 are (^{x}min₁, ^{y}min₁, ^{x}max₁, ^{y}max₁), and coordinates of the second text region TR2 are (^{x}min₂, ^{y}min₂, ^{x}max₂, ^{y}max₂), an overlapping length d₁ of a y-axis may be expressed as Equation 1 below.

$${d}_{1} = \{ \begin{matrix}{y}_{{max}_{1}} - {y}_{{min}_{2}} , & if {y}_{{min}_{1}} \leq {y}_{{min}_{2}} < {y}_{{max}_{1}} \\ {y}_{{max}_{2}} - {y}_{{min}_{1}} , & if {y}_{{min}_{2}} \leq {y}_{{min}_{1}} < {y}_{{max}_{2}} \\ 0 , & else\end{matrix} \qquad [ Equation 1 ]$$

Also, a spaced length d₂ of an x-axis may be expressed as Equation 2 below.

d₂=^{x}min₂−^{x}max₁ [Equation 2]

In addition, whether an overlapping area exists based on the y-axis may be identified using Equation 3, and whether an overlapping area exists based on the x-axis may be identified using Equation 4.

$${c}_{1} = \{ \begin{matrix}True , & if {d}_{1} > 0 \\ False , & else\end{matrix} \qquad [ Equation 3 ]$$

$${c}_{2} = \{ \begin{matrix}True , & if {d}_{2} \leq mean ( {x}_{1} , {x}_{2} ) \\ False , & else\end{matrix} \qquad [ Equation 4 ]$$

As shown above, when c₁ and c₂ True are all, the correction processing part 123 distinguishes the two text regions as being included in a single group, for example.

As described above, the correction processing part 123 may distinguish a plurality of text regions TR as being included in a single group and may distinguish groups on a metal plate. Referring to FIG. 5, it may be confirmed that five groups are distinguished on the metal plate. The correction processing part 123 may distinguish text regions distinguished as a group among the plurality of text regions, and may distinguish the groups of text regions, as shown in FIG. 5.

In an embodiment, after distinguishing the plurality of groups, the correction processing part 123 may select a group with the largest number of text regions among the plurality of groups as a main region MR. Here, when the number of text regions are identical to each other, the correction processing part 123 may select a group with a higher recognition score as the main region MR.

The above example operation is for selecting a notable group among the plurality of groups as the main region MR, because an unrequired group has a small number of text regions and a low recognition score.

The number of text regions in a group may be calculated by using Equation 5 below.

$$\begin{matrix}arg max \\ i ∈ 1 , 2 , 3 , … k\end{matrix} \{ {Count}_{1} \} \qquad [ Equation 5 ]$$

where Count₁ refers to the number of text regions TR in the group.

In an embodiment, the correction processing part 123 may select a group having the largest number of text regions, such as ‘TEXT SAMPLE’ in the example shown, as the main region MR.

In an embodiment, because the main region may be tilted by an angle θ, the correction processing part 123 calculates the tilted angle θ of text and makes correction in a horizontal direction in order to recognize text more accurately.

A center point of the text region may be calculated by using Equation 6, for example.

$${cx}_{i} = round ( \frac{{x}_{{min}_{1}} + {x}_{{max}_{1}}}{2} ) , \qquad [ Equation 6 ]$$

$${cy}_{i} = round ( \frac{{y}_{{min}_{1}} + {y}_{{max}_{1}}}{2} )$$

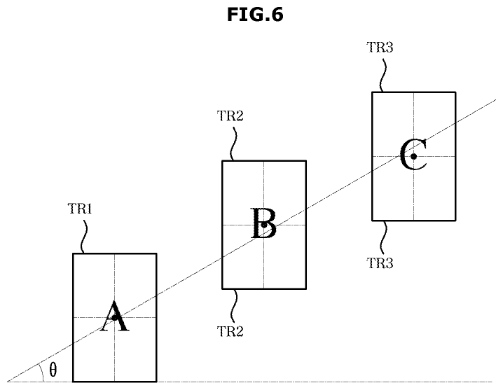

Here, (cxₙ, cyₙ) are center point coordinates of each text region. For example, as shown in FIG. 6, center point coordinates of the first text region TR1, the second text region TR2, and the third text region TR3 are calculated.

In addition, a simple linear regression slope of the center point coordinates of each of the text regions TR may be calculated by using Equation 7. Here, the simple linear regression slope connecting the center point coordinates of the first text region TR1, the second text region TR2, and the third text region TR3 is calculated.

$$\overline{cx} = \frac{{\sum }_{i = 1}^{n} {cx}_{i}}{n} , \overline{cy} = \frac{{\sum }_{i = 1}^{n} {cy}_{i}}{n} \qquad [ Equation 7 ]$$

$$b = \frac{{\sum }_{i = 1}^{n} ( {cx}_{i} - \overline{cx} ) ( {cy}_{i} - \overline{cy} )}{{\sum }_{i = 1}^{n} {( {cx}_{i} - \overline{cx} )}^{2}}$$

$$a = \overline{cy} - b \overline{cx}$$

As shown above, the tilted angle θ may be calculated by converting the slope into an arc tangent operation by using Equation 8, for example.

θ=arctan(α) [Equation 2]

Accordingly, the correction processing part 123 may rotate the entire image of the metal plate by the angle θ calculated by using center coordinates of the main region.

Here, the center coordinates of the main region may be calculated by using Equation 9, for example.

$$( {x}_{rotation} , {y}_{rotation} ) = ( round ( \frac{{x}_{{min}_{1}} + \text{?}}{2} ) , round ( \frac{{y}_{{min}_{1}} + \text{?}}{2} ) ) \qquad [ Equation 9 ]$$

$$\text{?} \text{indicates text missing or illegible when filed}$$

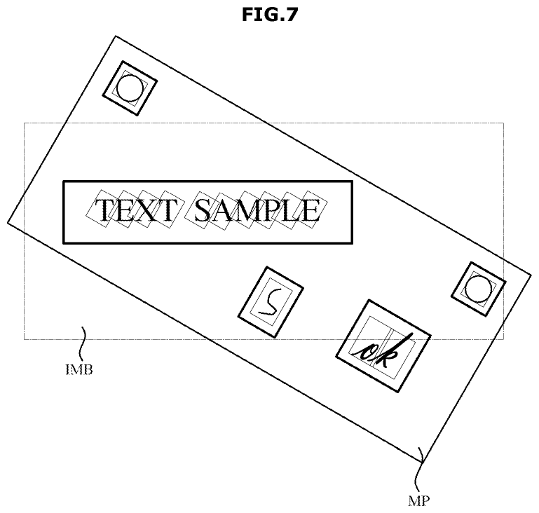

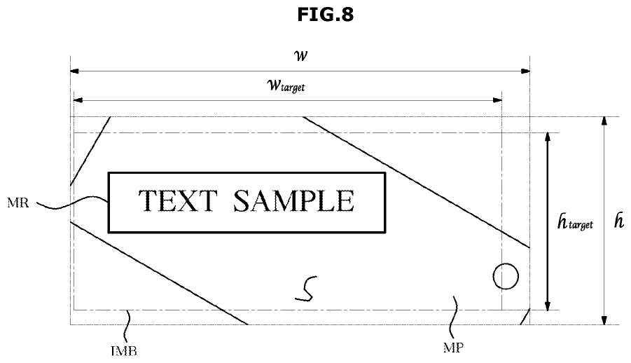

It is illustrated in FIG. 7 that the tilted main region MR is rotated towards a horizontal direction. Afterwards, as illustrated in FIG. 8, the correction processing part 123 may calibrate a magnification of the main region MR. To recognize characters of the main region MR more accurately, the correction processing part 123 may set an image box IMB of an appropriate size and may cut the image box out of the rotated image, for magnification calibration.

Based on training data, the size of the image box IMB may be calculated in comparison to a size of the text region of the image by using Equation 10, for example. Also, coordinates of the image box may be calculated in consideration of a width and a height of the image box by using Equation 11.

$$\overline{x} = \frac{{\sum }_{i = 1}^{n} {x}_{i}}{n} , \overline{y} = \frac{{\sum }_{i = 1}^{n} {y}_{i}}{n} , \qquad [ Equation 10 ]$$

$${w}_{target} = \frac{\overline{{w}_{lr}} \cdot \overline{x}}{\overline{{x}_{lr}}} , {h}_{target} = \frac{\overline{{h}_{lr}} \cdot \overline{y}}{\overline{{y}_{lr}}}$$

$$\text{?} = max ( {x}_{rotation} - \frac{{w}_{target}}{2} , 0 ) \qquad [ Equation 11 ]$$

$$\text{?} = min ( \text{?} + {w}_{target} , w )$$

$$\text{?} = max ( {y}_{rotation} - \frac{{y}_{target}}{2} , 0 )$$

$$\text{?} = min ( \text{?} + {h}_{target} , h )$$

$$\text{?} \text{indicates text missing or illegible when filed}$$

Here, w is a width of an original image, h is a height of the original image, xᵢ is a width of the text region, yᵢ is a height of the text region, w̅ₗ̅ᵣ̅ is an average image width of training data, h̅ₗ̅ᵣ̅ is an average image height of training data, x̅ₗ̅ᵣ̅ is a width of an average text region of training data, and y̅ₗ̅ᵣ̅ is a height of an average text region of training data. Also, w_{target} is a width of the image box, and h_{target} is a height of the image box.

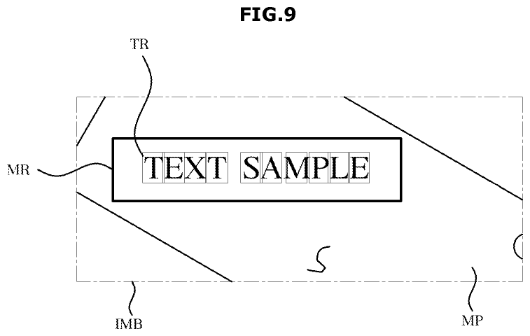

As described above, after cutting the image box using the coordinates of the image box IMB, the text recognition part 125 may perform text recognition in the main region MR of the image box IMB corrected by the correction processing part 123, as shown in FIG. 9. In an embodiment, the text recognition part 125 may perform text recognition based on inference by using a text recognition model.

The text recognition part 125 may utilize only the recognition result of the main region as a valid result, and may digitize and return characters of the valid result.

As described above, by use of the text recognition device 100, even though an angle of the camera 110 may be changed due to vibration or unexpected physical force while manufacturing the metal plate on which characters are engraved, when a portion of characters are recognized by the text recognition part 125, the text recognition part 125 may recognize an image corrected by the correction processing part 123. Accordingly, text may be recognized accurately, even without separate learning through deep learning.

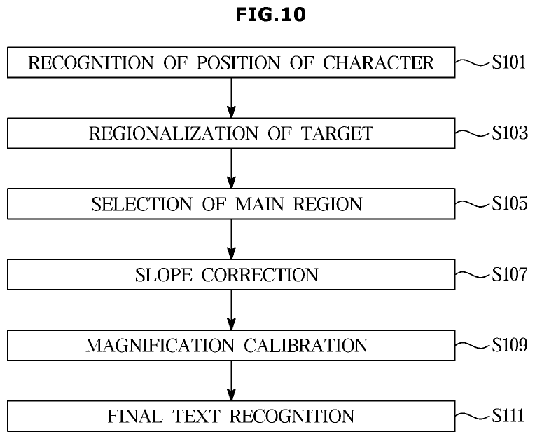

Meanwhile, a text recognition method according to an embodiment is described next with reference to FIG. 10 together with FIGS. 1 to 9.

Positions of characters are recognized in a captured image (S101).

The character position recognition part 121 recognizes the positions of characters in units of individual characters in the image captured by the camera 110 as shown in FIG. 2. The character position recognition part 121 recognizes the recognized characters and coordinate values of the position of each of the individual characters.

Here, in this embodiment, the character position recognition part 121 recognizes the individual characters using a text recognition model. Also, when recognizing characters, the character position recognition part 121 calculates a recognition score. The recognition score indicates a degree of recognition where the character position recognition part 121 recognizes the individual characters. The higher the recognition score, the more clearly the characters may be recognized.

Continuing with the method embodiment of FIG. 10, a target is regionalized using the positions of the recognized characters (S103).

When a plurality of characters is arranged in an image, the regionalization of target is performed to distinguish characters forming a group among the plurality of characters. The regionalization of target is performed by the correction processing part 123, for example.

When two text regions are spaced apart from each other, the correction processing part 123 performs regionalization by using at least one of an overlapping length and a spaced length of a first text region TR1 and a second text region TR2.

By distinguishing an area forming a group among the plurality of text regions through the regionalization, the correction processing part 123 distinguishes the text regions in the image into a plurality of groups. It is illustrated in FIG. 5 that five groups are distinguished, for example.

By using a method of calculating whether two text regions are included in a single group using Equation 3 and Equation 4, the correction processing part 123 distinguishes the plurality of text regions as a single group.

Continuing with the method embodiment of FIG. 10, a main region is selected (S105).

The correction processing part 123 selects the main region from the plurality of groups distinguished through the regionalization of target in operation S103, for example. A group with the largest number of text regions is selected as the main region, and when the number of text regions are identical to each other, a group with a higher recognition score may be selected.

The correction processing part 123 calculates the number of text regions included in the plurality of groups using Equation 5, for example.

Continuing with the method embodiment of FIG. 10, a slope of the main region is corrected (S107).

When the main region is tilted, the correction processing part 123 calculates a titled angle θ and makes correction toward a horizontal direction. The correction processing part 123 calculates center point coordinates of each text region in the main region by using Equation 6, calculates the slope of the main region using the center point coordinates of each of the text regions by using Equation 7, and calculates the titled angle θ by using Equation 8, for example.

As described above, the correction processing part 123 calculates the titled angle θ and then rotates the image so that the main region MR is horizontal (as illustrated in FIG. 7 for example).

Continuing with the method embodiment of FIG. 10, the correction processing part 123 calibrates a magnification of the text region in the main region (S109).

In this example, to recognize characters in the main region more accurately, the correction processing part 123 calibrates the magnification of the text region. The correction processing part 123 calculates a size of an image box for magnification calibration by using Equation 10, and calculates coordinates of the image box by using Equation 11, for example.

Accordingly, the correction processing part 123 performs magnification calibration by cutting the image box using the coordinates of the image box IMB (as illustrated in FIG. 9 for example).

Continuing with the method embodiment of FIG. 10, final text recognition is performed (S111).

The text recognition part 125 performs text recognition in the main region of the image box corrected through operation S103 to S109. The text recognition part 125 performs text recognition based on inference by using the text recognition model, for example. The text recognition part 125 may utilize only the recognition result of the main region as a valid result, and may digitize and return characters of the valid result.

As is apparent from the above, in an embodiment, the text recognition device and the text recognition method may quickly and accurately recognize text by correcting and recognizing target characters using a single text recognition model.

Also, in an embodiment, costs may be saved due to easy development and maintenance by use of a single model.

Although embodiments have been described for illustrative purposes, those skilled in the art will appreciate that various modifications, additions, and substitutions are possible, without departing from the scope and spirit of the disclosure. Therefore, embodiments have not been described for limiting purposes.

What is claimed is:

1. A text recognition device, comprising:
a character position recognizer configured to recognize individual characters in an image, and configured to recognize a position of each of the individual characters;
a correction processor configured to set a main region, the correction processor further being configured to perform one or both of correcting a slope of the main region and magnification calibration for at least one character recognized by the character position recognizer; and
a text recognizer configured to perform text recognition in the main region corrected by the correction processor.

2. The device of claim 1, wherein the correction processor is configured to distinguish an area forming a group among a plurality of text regions, by using one or both of an overlapping length and a spaced length of two adjacent text regions.

3. The device of claim 2, wherein, based on a plurality of groups being existent, the correction processor is configured to select one from the plurality of groups as the main region.

4. The device of claim 3, wherein the correction processor is configured to select a group with a largest number of text regions from the plurality of groups as the main region.

5. The device of claim 1, wherein the correction processor is configured to calculate a tilted angle of the main region and make correction towards a horizontal direction, based on the main region being tilted.

6. The device of claim 5, wherein the correction processor is configured to calculate center point coordinates of a plurality of text regions in the main region and calculate the slope of the main region using the center point coordinates of the plurality of text regions to calculate the tilted angle of the main region.

7. The device of claim 1, wherein the correction processor is configured to calculate a size and coordinates of an image box to be cut out from the image, to calibrate a magnification of a text region included in the main region.

8. The device of claim 1, wherein the text recognizer is configured to perform text recognition in the main region based on inference.

9. The device of claim 1, wherein one or both of the character position recognizer and the text recognizer is configured to perform text recognition using a text recognition model.

10. A text recognition method, comprising:
recognizing individual characters and a position of each of the individual characters in an image;
setting and selecting a main region for at least one recognized character;
calibrating a magnification of the selected main region; and
performing text recognition in the main region where the magnification is calibrated.

11. The method of claim 10, wherein the selecting of the main region comprises:
regionalizing a target by setting a text region for the recognized individual characters; and
selecting the main region from a plurality of groups.

12. The method of claim 11, wherein the regionalizing of the target distinguishes an area forming a group among a plurality of text regions, by using one or both of an overlapping length and a spaced length of two adjacent text regions, for regionalization.

13. The method of claim 12, wherein the selecting of the main region from the plurality of groups selects a group with a largest number of text regions from the plurality of groups as the main region.

14. The method of claim 10, further comprising:
correcting a slope of the selected main region, based on the selected main region being tilted,
wherein the calibrating of the magnification calibrates the magnification in the image where the slope is corrected.

15. The method of claim 14, wherein the correcting of the slope calculates a tilted angle of the main region and makes correction towards a horizontal direction.

16. The method of claim 15, wherein the correcting of the slope calculates center point coordinates of a plurality of text regions in the main region and calculates the slope of the main region using the center point coordinates of the plurality of text regions to calculate the tilted angle of the main region.

17. The method of claim 10, wherein the calibrating of the magnification calculates a size and coordinates of an image box to be cut out from the image, to calibrate the magnification.

18. The method of claim 10, wherein the performing of the text recognition performs text recognition in the main region based on inference.

19. The method of claim 10, wherein one or both of the recognizing of the position of each of the individual characters and the performing of final text recognition, uses a text recognition model to perform text recognition.

20. The method of claim 10, wherein the image is captured by a camera.
